(19) United States
(12) Patent Application Publication
(10) Pub. No.: US 2026/0160960 A1
(43) Pub. Date: Jun. 11, 2026

(54) PHOTONIC FANOUT INTERPOSER

(71) Applicant: Lightmatter, Inc., Boston, MA (US)

(72) Inventors: Omkar Karhade, Chandler, AZ (US); Nicholas C. Harris, Menlo Park, CA (US); Shashank Gupta, Gurugram (IN)

(73) Assignee: Lightmatter, Inc., Boston, MA (US)

(21) Appl. No.: 19/412,235

(22) Filed: Dec. 8, 2025

Related U.S. Application Data
(60) Provisional application No. 63/729,802, filed on Dec. 9, 2024.

(51) Int. Cl. G02B 6/42

(52) U.S. Cl. CPC G02B 6/4214; G02B 6/4202; G02B 6/4244; G02B 6/4245; G02B 6/4249; G02B 6/4257; G02B 6/4269; G02B 6/4291

(57) ABSTRACT

Described herein are systems and techniques for providing photonic devices having glass substrates for use in an optical interconnect system. The photonic devices comprise a glass substrate and one or more optoelectronic assemblies coupled through openings of the glass substrate. Waveguides of the optoelectronic assemblies may be optically coupled with waveguides of the glass substrate forming an optical network through the glass substrate. The assembly waveguides may be optically coupled to the glass waveguides through pluggable optical couplers, evanescent coupling, and/or edge coupling.

### CROSS-REFERENCE TO RELATED APPLICATIONS

This application claims the benefit of U.S. Provisional Application Ser. No. 63/729,802, filed on Dec. 9, 2024, under Attorney Docket No. L0858.70108US00 and entitled “PHOTONIC FANOUT INTERPOSER,” which is hereby incorporated herein by reference in its entirety.

### BACKGROUND

Optical interconnects are a type of communication technology that use light signals to transmit data between different components or devices within a system. Wafer level optical packaging has helped achieve higher performance levels for optical interconnect systems, facilitating high-speed data transfer and improved computational efficiency. Conventionally, silicon-on-insulator (SOI) wafers are commonly used for wafer level photonic integrated circuits (PICs) owing to their capability to integrate optical and electrical components.

### SUMMARY

The inventors have developed the systems and techniques described herein to provide optical networks for an optical interconnect system using a glass substrate. Where conventional SOI substrates may experience higher loss, glass substrates can provide lower loss (e.g., <0.1 dB/cm) optical connections between various optoelectronic assemblies disposed on the substrate. Further, glass substrates ensure that only yielded assemblies are used and allow for easy replacement of defective assemblies.

In some aspects, the techniques described herein relate to a photonic device, including: a glass substrate, having a first surface and a second surface opposite the first surface, including: an optical network having one or more glass waveguides; and a plurality of openings extending through the glass substrate from the first surface to the second surface; and a plurality of assemblies secured within respective ones of the plurality of openings, each assembly including: a photonic integrated circuit (PIC) having a waveguide optically coupled to at least one glass waveguide of the one or more glass waveguides; and an application-specific integrated circuit (ASIC) attached to the PIC.

In some aspects, the techniques described herein relate to a photonic device, wherein the one or more glass waveguides are formed adjacent the first surface of the glass substrate, the photonic device further including a glass cladding disposed on the first surface of the glass substrate.

In some aspects, the techniques described herein relate to a photonic device, wherein the waveguide of the PIC is optically coupled to the at least one glass waveguide by a first optical coupler disposed on the glass substrate and a second optical coupler disposed on the PIC.

In some aspects, the techniques described herein relate to a photonic device, wherein the second optical coupler is disposed in a recess formed in the PIC.

In some aspects, the techniques described herein relate to a photonic device, wherein the first optical coupler includes a first mirror and the second optical coupler includes a second mirror.

In some aspects, the techniques described herein relate to a photonic device, wherein the waveguide of the PIC is optically coupled to the at least one glass waveguide by evanescent coupling.

In some aspects, the techniques described herein relate to a photonic device, wherein the waveguide of the PIC is optically coupled to the at least one glass waveguide by edge coupling.

In some aspects, the techniques described herein relate to a photonic device, wherein the PIC defines a ledge configured to engage with the glass substrate to enable edge coupling between the waveguide of the PIC and the at least one glass waveguide.

In some aspects, the techniques described herein relate to a photonic device, wherein each of the PICS of the plurality of assemblies is attached to a distinct substrate.

In some aspects, the techniques described herein relate to a photonic device, wherein the PICS of the plurality of assemblies are attached to a same substrate.

In some aspects, the techniques described herein relate to a photonic device, further including a bracket attached to the glass substrate and configured to secure the assemblies within the openings of the glass substrate.

In some aspects, the techniques described herein relate to a photonic device, further including one or more heat sinks thermally coupled to the ASICs at the second surface of the glass substrate.

In some aspects, the techniques described herein relate to a method of assembling a photonic device, the method including: obtaining a plurality of photonic integrated circuits (PICs), each PIC having a waveguide patterned thereon; attaching a plurality of application-specific integrated circuit (ASICs) to respective PICs of the plurality of PICs to form a plurality of assemblies; and inserting the plurality of assemblies into respective openings of a glass substrate, wherein the openings extend from a first surface of the glass substrate to a second surface of the glass substrate opposite the first surface, wherein inserting the plurality of assemblies into the respective openings includes optically coupling glass waveguides of the glass substrate to respective waveguides of the PIC.

In some aspects, the techniques described herein relate to a method, wherein inserting the plurality of assemblies into the respective openings of the glass substrate includes exposing the ASICs at the second surface of the glass substrate.

In some aspects, the techniques described herein relate to a method, further including attaching one or more heat sinks to the second surface of the glass substrate such that the one or more heat sinks is in thermal contact with the ASICs.

In some aspects, the techniques described herein relate to a method, further including: etching the plurality of PICs to form a recess in each PIC; and placing a first plurality of optical couplers in respective recesses of the PICs, wherein when the plurality of assemblies are inserted into the respective openings, the glass waveguides of the glass substrate are optically coupled to the respective waveguides of the PIC through the first optical couplers.

In some aspects, the techniques described herein relate to a method, further including: etching the glass substrate to form a plurality of recesses; and placing a second plurality of optical couplers in the recesses of the glass substrate, wherein when the plurality of assemblies are inserted into the respective openings, the glass waveguides of the glass substrate are optically coupled to the respective waveguides of the PIC through the first and second plurality of optical couplers.

In some aspects, the techniques described herein relate to a method, further including securing the plurality of assemblies to the glass substrate using one or more brackets.

In some aspects, the techniques described herein relate to a method, further including attaching the plurality of assemblies to a common substrate.

In some aspects, the techniques described herein relate to a method, further including attaching the plurality of assemblies to respective substrates of a plurality of substrates.

### BRIEF DESCRIPTION OF DRAWINGS

Various aspects and embodiments of the application will be described with reference to the following figures. It should be appreciated that the figures are not necessarily drawn to scale. Items appearing in multiple figures are indicated by the same or similar reference number in the figures in which they appear. In the figures:

FIG. 1A illustrates a first side of photonic device having a glass substrate and a plurality of optoelectronic assemblies coupled with the glass substrate, according to some embodiments;

FIG. 1B illustrates the second side of the photonic device of FIG. 1A, according to some embodiments;

FIG. 2 illustrates a cross sectional view of a photonic device having a glass substrate and a plurality of optoelectronic assemblies coupled with the glass substrate, according to some embodiments;

FIG. 3 illustrates a method of manufacturing an optoelectronic assembly, according to some embodiments;

FIG. 4 illustrates a method of manufacturing a glass substrate, according to some embodiments;

FIG. 5 illustrates a cross sectional view of a photonic device having a plurality of optoelectronic assemblies evanescently coupled with a glass substrate, according to some embodiments;

FIG. 6 illustrates a method of manufacturing a photonic device, according to some embodiments;

FIG. 7A illustrates a cross sectional view of a photonic device having a plurality of optoelectronic assemblies evanescently coupled with a glass substrate, according to some embodiments; and

FIG. 7B illustrates a zoomed in view of the photonic device of FIG. 7A, according to some embodiments.

### DETAILED DESCRIPTION

While conventionally, silicon-on-insulator (SOI) wafers have provided high-speed data transfer and improved computational efficiency, the inventors have recognized and appreciated that SOI wafers may not scale with the increasing performance demands. For example, machine learning and artificial intelligence-based tools and algorithms may have higher performance requirements than conventional computational algorithms. The inventors have recognized and appreciated that SOI wafers present significant drawbacks including high optical loss—in some circumstances, greater than 0.3 dB/cm—and elevated manufacturing costs. High optical loss in SOI wafers used for wafer level photonic integrated circuits (PICs) lead to more signal degradation over longer distances between components. Elevated manufacturing costs associated with SOI wafers make them less economically feasible for large-scale deployment in high-performance computing applications.

The inventors have further recognized and appreciated that glass, rather than SOI wafers, offers low-loss photonic waveguides, allowing signals to travel longer distances with minimal degradation. In some examples, the glass waveguides in a glass wafer may offer loss less than 0.1 dB/cm. However, glass lacks the ability to integrate active photonics, transistors, logic circuits, or other electronic components. Accordingly, the inventors have developed the systems and techniques described herein to provide wafer level packaging comprising glass substrates with which one or more PICs can be optically coupled. In that way, the systems and techniques described herein harness the low optical loss properties of the glass substrate while integrating it with the PIC to provide advanced photonic functionality.

Some embodiments described herein provide for a photonic device having a glass substrate with openings etched therethrough. The glass substrate may have a plurality of waveguides etched thereon to form an optical network through the glass substrate (e.g., between openings, between an opening and a fiber coupler for an external fiber). One or more PICs having waveguides may be inserted into respective openings to be optically coupled with the optical network of the glass substrate. The PICs may include optical circuit switching (OCS) capabilities to facilitate optical communication through the optical network of the glass substrate between PICs or between a PIC and an external device. Each of the PICs may be coupled with an electronic application-specific integrated circuit (ASIC) to provide electronic functionality to the photonic device. The ASICs may include any suitable electronic component for example a memory chip (e.g., high bandwidth memory) or a compute chip (e.g., a central processing units (CPU), a graphics processing (GPU), a tensor processing unit (TPU), an accelerator or any other suitable xPU). The PICs may be optically coupled with the glass waveguides on the glass substrate in various manners, for example, employing pluggable optical couplers, evanescent coupling, or edge coupling as described herein.

Using a glass substrate, as opposed to a SOI wafer, provides a number of benefits. First, as glass substrates are passive in nature, the typical yield of a glass substrate is significantly higher than SOI wafers which may include active photonic elements. Active photonic components (e.g., photonic transceivers and switches) tend to be more susceptible to manufacturing defects than passive photonic components (e.g., waveguides and couplers) because active components require additional manufacturing steps (e.g., ion implantation, sputtering, epitaxial growth, etc.). This approach improves performance because instead of having to slice a large number of continuous reticles, one can pick and choose reticles known to have yielded. The modular nature and pluggable coupling in some embodiments further enables easy replacement of defective reticles. Warpage that may be caused during manufacture of SOI PICs is avoided by using single reticles rather than the entire SOI wafer. Further, using glass substrates in the manner described herein provides more flexibility than SOI wafers in that it enables use of PICS having different patterns. By contrast, SOI wafers and reticle stitched photonic interposers typically share a common pattern as the other reticles.

Further, utilizing glass substrates may enable tight pitch optical coupling. Some embodiments described herein may provide a pitch of less than 130 μm, for example, 127 μm. Some embodiments described herein may provide a pitch of less than 40 μm.

In some embodiments, the photonic devices described herein may be configured to employ wavelength-division multiplexing (WDM) where multiple wavelengths (e.g., spaced 50, 100, 200, or 400 GHz apart in dense WDM, or more than 400GHz apart in coarse WDM) are transported over the same physical waveguide or optical fiber. The glass waveguides as well as the PIC waveguides within the PIC may be compatible with coarse or dense WDM. In some embodiments, the photonic devices described herein may be configured to employ polarization multiplexing where two orthogonal polarizations of light are transported over the same physical waveguide or optical fiber.

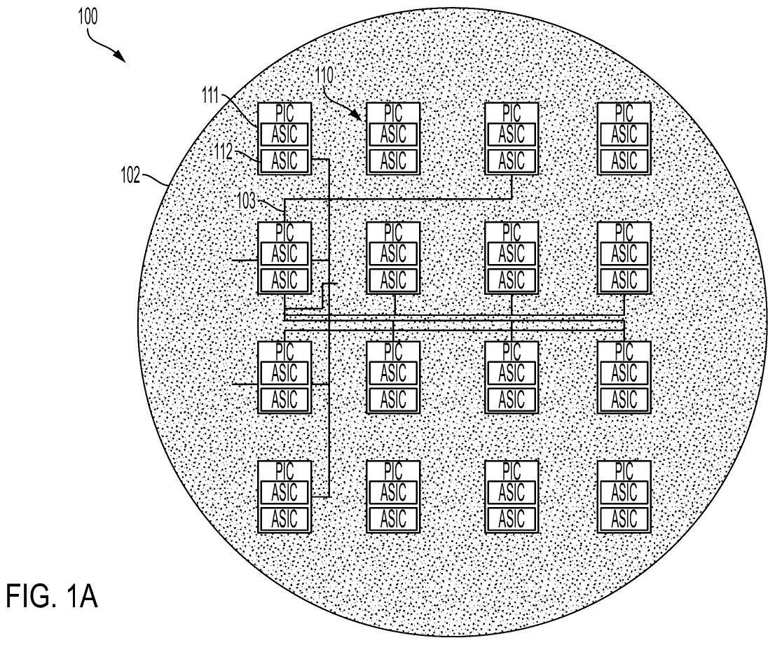

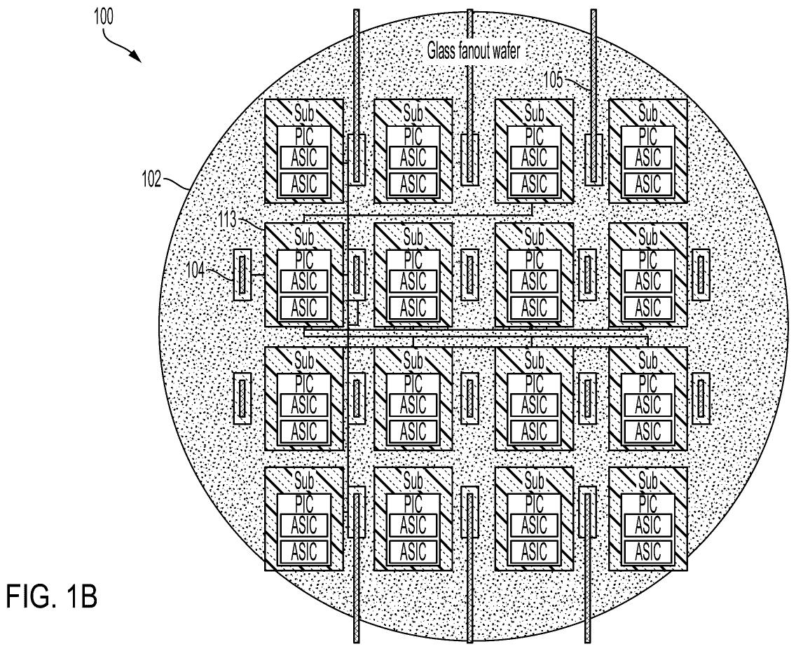

FIG. 1A illustrates a first side of photonic device 100 having a glass substrate 102 and a plurality of optoelectronic assemblies 110 coupled with the glass substrate, according to some embodiments. FIG. 1B illustrates the second side of photonic device 100 of FIG. 1A. Glass substrate 102 includes a plurality of openings through which optoelectronic assemblies 110 extend to be optically coupled with glass substrate 102.

The openings may extend fully through the glass substrate 102 from the first side to the second side. An optical network of glass waveguides 103 extends through glass substrate 102 to optically couple the various optoelectronic assemblies 110 with each other and/or with external optical devices.

Glass substrate 102 may be made of any suitable type of glass, including for example SiO₂, fused silica, or borosilicate glass. The glass substrate 102 may be passive in nature in that it may include passive optical devices (e.g., waveguides, passive couplers, waveguide crossings, wavelength multiplexers/demultiplexers, etc.) but may omit active optical devices (e.g., modulators, detectors, switches, etc.). In the illustrated embodiment, glass substrate 102 includes a plurality of glass waveguides 103 to form an optical network through glass substrate 102 and fiber array couplers 104 (FIG. 1B) for optically connecting photonic device 100 with external devices (e.g., through optical fiber(s) 105). In some embodiments, fiber array couplers 104 may be disposed on PICs 111 of the optoelectronic assemblies 110, or the photonic device 100 may include fiber array couplers 104 on both glass substrate 102 and one or more PICS 111.

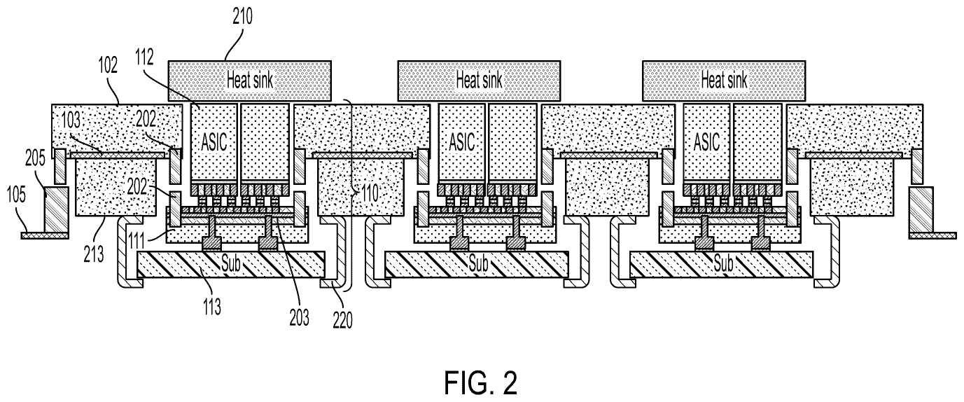

Glass waveguides 103 may be used to route light from one part of the glass substrate 102 to another, thereby forming a network optically coupling the optoelectronic assemblies 110 to each other and/or to external devices (e.g., through fiber array couplers 104). The glass waveguides 103 may be made of any suitable material that is compatible with the technology used to fabricate the glass substrate 102. The glass waveguides 103 can be made in-situ within the glass substrate 102 itself with lithography or laser writing. In another embodiment, the glass waveguides 103 and the passive optical components within the glass substrate 102 can be manufactured using ion-exchange processes. Different glass compositions may inform which manufacturing process may be used. Further, the glass waveguides 103 may be made of a material having a refractive index greater than the refractive index of the surrounding material, thus ensuring that the optical signal mode is sufficiently contained and guided within the waveguide. For example, the glass substrate 102 may be made of SiO₂ and the waveguides may be made of SiO₂ doped to have a larger refractive index and/or be made of silicon nitride (e.g., grown, deposited, or bonded). In some embodiments, the glass waveguides 103 may be formed near the surface of the glass substrate 102 (e.g., adjacent the second side in the illustrated embodiment). In that way, the waveguides may be easily accessed for coupling with the optoelectronic assemblies 110 and fiber array couplers. In some embodiments, glass substrate 102 may include a protective cladding (discussed below with respect to FIG. 2) at the surface adjacent the glass waveguides 103 to protect the waveguides and spatially confine the optical mode, further reducing optical loss.

The optoelectronic assemblies 110 are disposed within the openings extending through glass substrate 102. The optoelectronic assemblies 110 each comprise a PIC 111, one or more ASICs 112, and a substrate 113. This arrangement allows the waveguides of PICs 111 of the assemblies to be aligned and optically coupled with glass waveguides 103. The ASICs may comprise any suitable electronic integrated circuit (EIC) for performing electronic functions of the photonic device 100 (e.g., memory storage, processing, electronic control of other components, electronic switching components). For example, each ASIC 112 may comprise a memory chip (e.g., high bandwidth memory), a compute chip (e.g., CPU, GPU, TPU, xPU, accelerator), a switching chip, an input/output (I/O) chip, a serializer/deserializer (SerDes) and/or any other suitable electronic chip component.

Further, although as illustrated each optoelectronic assembly 110 comprises a separate substrate 113, two or more optoelectronic assemblies may share a common substrate. In some embodiments, all of the optoelectronic assemblies 110 may share a common substrate. Each substrate 113 may comprise an organic substrate attached to, and electrically coupled to, a PIC 111.

In contrast with the glass substrate 102, PICs 111 may be active in nature in that they may include modulators, photodetectors, and optical switches (and/or other active components). For example, each PIC 111 may have an optical transmitter and an optical receiver. Data may be transmitted by the optical transmitter of a PIC to the optical receiver of another PIC via glass waveguides 103. In some embodiments, each PIC 111 may support bidirectional communication. Further, the PICs 111 may include optical switches and controllers configured to route data to and from any one among the ASICs disposed in a single optoelectronic assemblies 110 or in two separate optoelectronic assemblies 110. The optical switching components may adjust the interconnection topology according to the application being executed by the photonic device 100. The optical switching elements may further allow for the use of redundant optical elements within the PICS, to improve yield of the PIC. For example, a PIC may include two optical transceivers where, when one does not yield, the optical switching components may be used to select the yielded transceiver to couple with the rest of the network.

As noted above, PICs 111 may be optically coupled to glass substrate 102 in various manners. In some embodiments, PICs 111 are optically coupled to glass substrate 102 via pluggable optical couplers. Pluggable coupler technology may allow optical coupling even in the event of significant misalignment (e.g., 20-50 μm or more) without active alignment. This enables high throughput bonding of optoelectronic assemblies 110 with glass substrate 102. FIG. 2 illustrates a cross sectional view of the photonic device of FIG. 1A, according to some embodiments. In the illustrated embodiment, optoelectronic assemblies 110 are optically coupled to glass substrate 102 via pluggable optical couplers 202 which may be disposed on both PIC 111 and glass substrate 102 to couple PIC waveguides 203 with glass waveguides 103. Although only two pairs of optical couplers 202 are shown per optoelectronic assembly 110, it can be appreciated that any suitable number of pairs of optical couplers 202 may be used. For example, the number of pairs of optical couplers 202 employed may depend on the number of glass waveguides 103 optically couplable with the optoelectronic assembly 110 through a particular opening. For example, if three glass waveguides 103 extend towards and surround an opening, three pairs of optical couplers 202 may be used so that optoelectronic assembly 110 disposed in that opening is optically coupled with each waveguide. In some embodiments, a subset of optical couplers 202 disposed on glass substrate 102 may be configured to be optically coupled with an optical fiber 105 via plug 205. In some embodiments, plug 205 may comprise a fiber array unit (FAU) configured to optically couple one or more fibers (e.g., a single fiber or fiber array) to the optical network of glass substrate 102. Optical couplers 202 may comprise one or more optical coupling components including for example, grating couplers, lens and mirror assemblies, or any other suitable optical coupling component. For example, coupling the glass waveguide 103 and PIC waveguide 203 may comprise using lens and mirror assemblies. The lens and mirror assembly of the optical coupler 202 on glass substrate 102 may receive and redirect an optical signal from glass waveguide 103 towards the second optical coupler 202 on PIC 111, which may receive and redirect the optical signal to PIC waveguide 203. An optical signal traveling in the other direction may be redirected from the PIC waveguide 203 to glass waveguide 103 in a similar manner.

Because the openings extend fully through glass substrate 102, ASICs 112 may be exposed from glass substrate 102. This arrangement allows heat sinks 210 to be attached to the ASICs, whether directly or through a thermal interface material (e.g., a thermal adhesive or thermal paste). The openings may provide a thermal path allowing heat generated by the electronic components to be dissipated to the surrounding environment. In the illustrated embodiment, optoelectronic assemblies 110 extend fully through the openings from the first to the second side of glass substrate 102. However, the technology is not limited in this manner and the assemblies may extend only partially through the openings or may extend beyond glass substrate 102. In some embodiments, heat sinks 210 may be individually thermally coupled to respective ASICs 112 of the assemblies. In other embodiments, one heat sink 210 may be placed in thermal contact with two or more ASICs 112. For example, a single heat sink 210 may be placed in thermal contact to all the ASICs 112 of the device.

As noted above, glass waveguides 103 may be formed near a surface of glass substrate 102. This may cause glass waveguides 103 to be susceptible to surface scattering, leading to optical loss. To reduce loss due to surface scattering, some embodiments may include a cladding 213 to protect glass waveguides 103 and spatially confine the optical mode. Claddings 213 may comprise separate glass substrates that can be attached to glass substrate 102 in correspondence with glass waveguides 103.

In some embodiments, to secure the optoelectronic assemblies 110 within the openings of glass substrate 102, photonic device 100 may employ brackets 220. Brackets 220 may be configured to engage with substrate(s) 113 to secure optoelectronic assemblies 110 within the openings. A bracket 220 may comprise a fastener having one end configured to attach to a cladding 213 (or directly to glass substrate 102) and one end configured to attach to a substrate 113.

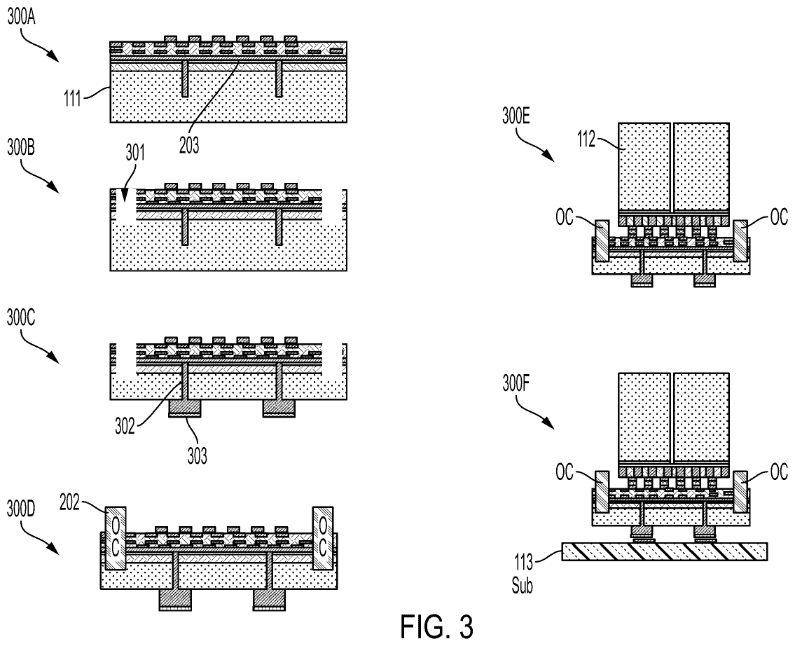

FIG. 3 illustrates a method of manufacturing an optoelectronic assembly 110, according to some embodiments. The method begins at act 300A with obtaining a PIC 111. The PIC 111 includes one or more waveguides 203 patterned thereon. PIC 111 may further include one or more electronic coupling components for coupling electronic and optoelectronic components of the assembly. For example, PIC 111 may include conductive traces, through-silicon vias (TSVs), or other electronic coupling components.

The method proceeds to act 300B with creating one or more recesses 301 in PIC 111. Recesses 301 are configured to receive an optical coupler 202 and may extend through PIC 111 past waveguides 203 to enable optical coupling of the waveguides 203 through optical coupler(s) 202. Recesses 301 may be created in PIC 111 in any suitable manner, including but not limited to, dry etching or wet etching.

At act 300C, the method proceeds with removing a portion of the substrate of PIC 111 to reveal TSVs 302. Additionally, coupling conductive pads 303 may be formed to be electrically coupled to TSVs 302. Conductive pads 303 may comprise TSV bumps formed in any suitable manner. Conductive pads 303 may comprise solder bumps. The portion of the PIC 111 removed may be on the opposite side of PIC 111 from recesses 301. In that way, conductive pads 303 may be configured to facilitate mounting and electronic coupling of PIC 111 to a substrate 113. The PIC 111 may be etched or grinded to remove the portion to reveal TSVs 302.

At act 300D, optical couplers 202 may be attached to PIC 111 within recesses 301. Optical couplers 202 may be attached to PIC 111 in any suitable manner. For example, in some embodiments, optical couplers 202 may be bonded within recesses 301 using index-matched epoxy.

At act 300E, one or more ASICs 112 are attached to PIC 111. ASICs 112 may be attached to PIC 111 in any suitable manner, including for example, using hybrid bonding or C4 bonding. An underfill may fill the space between ASICs 112 and PICs 111. As noted above, ASICs 112 may include any suitable electronic component including, but not limited to, memory chips (e.g., high bandwidth memory), compute chips (e.g., CPUs, GPUs, TPUs, xPUs, accelerators, etc.), switching chips, and/or I/O chips, for example.

At act 300F, the assembly may be attached to a substrate 113. In some embodiments, substrate 113 is attached to PIC 111 (e.g., on the opposite side from ASICs 112). Substrate 113 may be attached to PIC 111 in any suitable manner, including for example, using an underfill to bond PIC 111 to substrate 113. Any suitable number of assemblies may be attached to a single substrate 113. In some embodiments, each assembly includes a respective substrate 113. In some embodiments, two or more assemblies may share a common substrate 113.

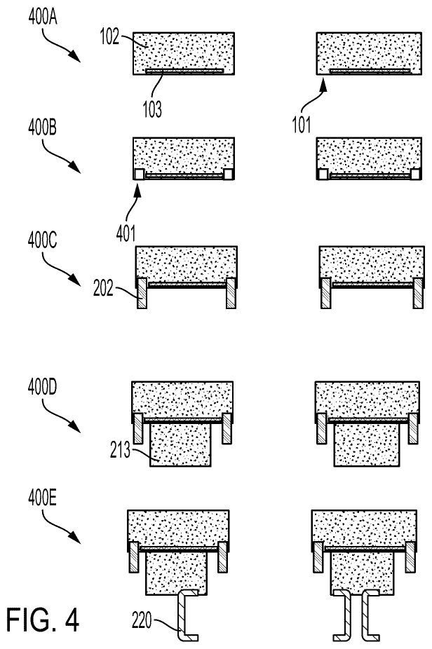

FIG. 4 illustrates a method of manufacturing a glass substrate 102, according to some embodiments. The method begins at act 400A with obtaining a glass substrate 102. Glass substrate 102 includes one or more openings 101 etched therethrough from a first side of glass substrate 102 to a second side, opposite the first side. For clarity, only a portion of glass substrate 102 having one opening 101 is illustrated. Further, although it appears to be two separate substrates due to opening 101, it can be appreciated that the two illustrated portions are connected in an orthogonal cross-sectional plane.

As described above with respect to FIGS. 1A and 1B, glass substrate 102 may include any suitable number of openings 101. Glass substrate 102 may further include an optical network of waveguides 103 optically coupling various openings in glass substrate 102. Glass waveguides 103 may be formed near one side of the glass substrate. The glass waveguides 103 can be made in-situ within the glass substrate 102 itself with lithography or laser writing. In another embodiment, the glass waveguides 103 and the passive optical components within the glass substrate 102 can be manufactured using ion-exchange processes. Different glass compositions may inform which manufacturing process may be used.

At act 400B, one or more recesses 401 may be created in the side of glass substrate 102 having waveguides 103. Recesses 401 may be created in glass substrate 102 in any suitable manner, including for example, etching. Each opening 101 may include two or more recesses 401 surrounding the opening 101.

At act 400C, optical couplers 202 may be attached to glass substrate 102 in recesses 401. Optical couplers 202 may be attached to glass substrate 102 in any suitable manner, for example, using index-matched epoxy.

The number and pattern of recesses 401 surrounding an opening 101 may mirror that of the arrangement of recesses 301 on optoelectronic assemblies 110 (e.g., as discussed above with respect to FIG. 3). In that way, the assemblies may be pluggably coupled with glass substrate 102 through openings 101 using optical couplers 202 on the glass substrate 102 and optical couplers 202 on PIC 111 of the assemblies.

At act 400D, cladding 213 is attached to glass substrate 102 on the side adjacent waveguides 103. In some embodiments, cladding 213 may be made of the same material as glass substrate 102. In that way, cladding 213 may protect waveguides 103 and reduce optical loss.

At act 400E, brackets 220 are attached to cladding 213. Brackets 220 may be configured to engage with a substrate 113 of optoelectronic assemblies 110 to secure the assemblies within openings 101 and ensure optical coupling of PIC 111 and glass substrate 102. Although the illustrated embodiment shows a pair of brackets 220 per opening 101, in embodiments where multiple assemblies share a common substrate 113, a pair of brackets 220 may span two or more openings 101.

Once the glass substrate 102 is manufactured, one or more optoelectronic assemblies 110 may be plugged into glass substrate 102 through openings 101. Optical couplers 202 on glass substrate 102 may be coupled with optical couplers 202 on PIC 111 of the assemblies. Utilizing optical couplers 202 enables easy, pluggable coupling that does not require any active alignment. In that way, plugging the assemblies into glass substrate 102 couples the assemblies to the optical network of glass substrate 102.

In some embodiments, rather than optically coupling the assemblies to the glass substrate using pluggable optical couplers, the PIC waveguides may be optical coupled to the glass waveguides via evanescent coupling. Because of the removal of the pluggable optical couplers, embodiments employing evanescent coupling may provide tighter pitches than embodiments using pluggable assemblies. In some embodiments, the pitch may be less than 40 μm.

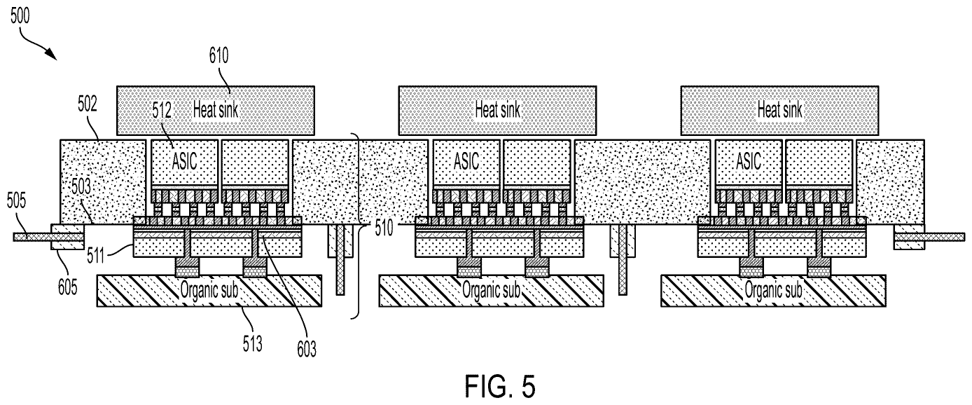

FIG. 5 illustrates a cross sectional view of a photonic device 500 having a plurality of optoelectronic assemblies evanescently coupled with a glass substrate, according to some embodiments. Like photonic device 100 described above, photonic device 500 includes a glass substrate 502 having an optical network of waveguides 503 and a plurality of optoelectronic assemblies 510 disposed in openings of glass substrate 502. Where photonic device 500 differs from photonic device 100 is that PIC waveguides 603 of PIC 511 are optically coupled to glass waveguides 503 via evanescent coupling. As such, neither glass substrate 502 nor optoelectronic assemblies 510 include optical couplers. Rather, the surfaces of PICs 111 are attached to the waveguide side of glass substrate 502 along an edge of PICs 111. In doing so, the proximity of the glass waveguides 503 at the surface of glass substrate 502 and PIC waveguides 603 at the surface of PIC 111 optically couples the waveguides. PIC 111 may be attached to the surface of glass substrate 502 in any suitable manner, for example, using index-matched epoxy (e.g., additionally or alternatively to brackets 220 described above with respect to photonic device 100). Further, to ensure proximity between the waveguides, photonic device 500 may not include a cladding.

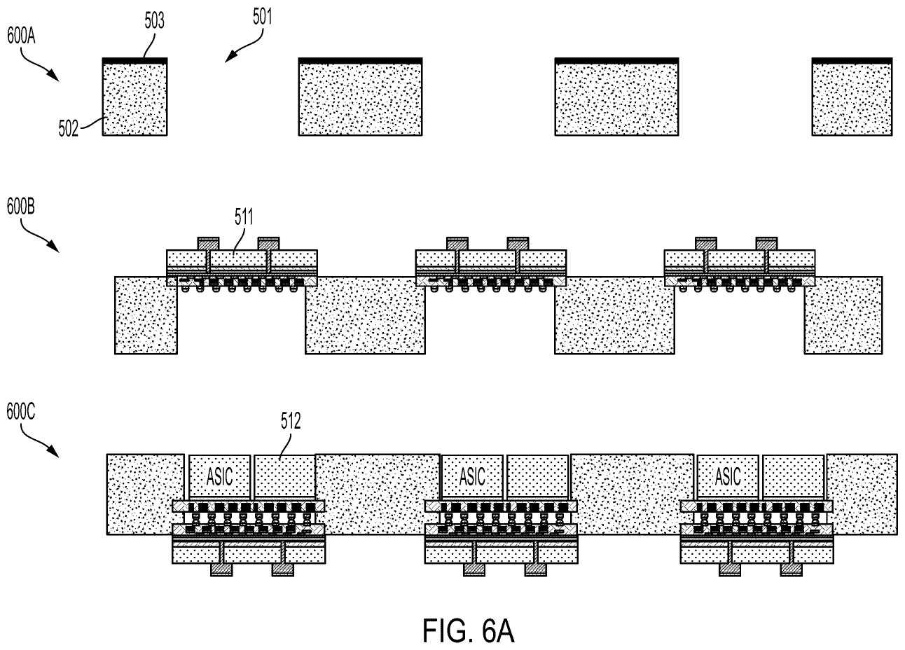

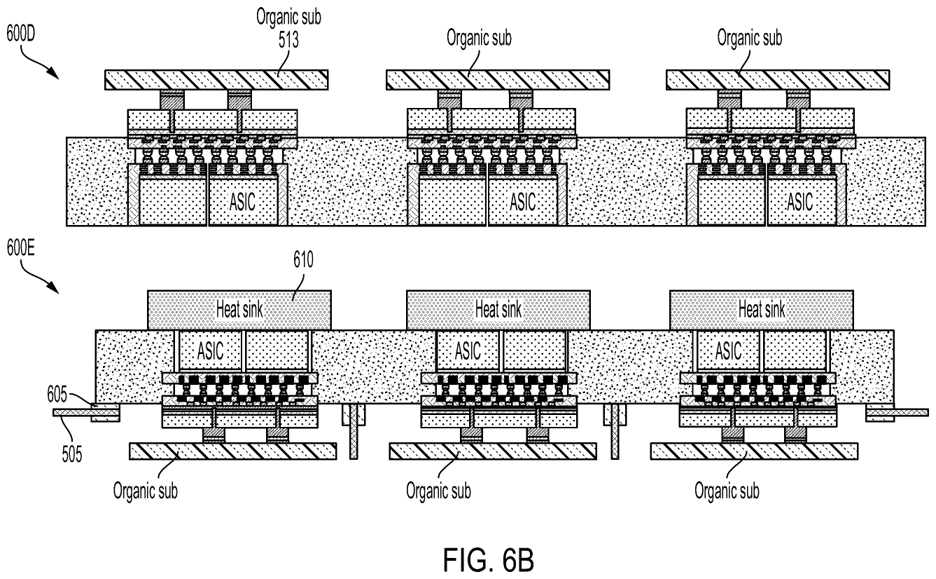

Because evanescent coupling utilizes surface bonding to couple the glass waveguides and PIC waveguides, some embodiments described herein may be manufactured according to the process described with respect to FIG. 6. FIG. 6 illustrates a method of manufacturing a photonic device 500, according to some embodiments. At act 600A, a glass substrate 502 is obtained having an optical network comprising glass waveguides 503. Glass waveguides 503 may be formed near a first surface of glass substrate 502. The glass substrate 502 may have a plurality of openings 501 etched therethrough (or may be subsequently etched after having been received).

At act 600B, one or more patterned PICs 511 may be attached to the first surface of glass substrate 502. PICs 511 may be patterned with one or more PIC waveguides 603 near a first surface of PIC 511. As such, the first surface of PIC 511 may be bonded to the first surface of glass substrate 502. In some embodiments, PIC 511 may at least partially extend into respective openings 501 of glass substrate 502. PIC(s) 511 may be attached in any suitable manner. In some embodiments, PIC(s) 511 may be attached using index-matched epoxy. In some embodiments, to provide effective evanescent coupling with minimal loss, the gap between PIC 511 and glass substrate 502 may be sufficiently small. In some embodiments, the gap may be approximately equal to or less than 2 μm. Other optical coupling mechanisms may be used in addition to, or alternatively to evanescent coupling, including for example, grating couplings and/or lens-mirror assemblies coupled to the waveguides.

At act 600C, one or more ASICs 512 are attached to PICS 511 through openings 501. ASICs 512 may be inserted into openings 501 from the second side of glass substrate 502 and subsequently bonded to PICS 511. ASICs 512 may be attached to PICS 511 in any suitable manner, including for example, using an underfill to secure ASICS 512 to PICS 511.

At act 600D, one or more substrates 513 may be attached to PICS 511. As noted above, each assembly may have a respective substrate 513 or two or more assemblies may share a common substrate.

At act 600E, additional components may be attached to the photonic device. For example, in some embodiments, heat sink(s) 610 may be thermally coupled to one or more assemblies as described above with respect to heat sink(s) 210. In some embodiments, one or more optical fibers 505 may be attached to glass substrate 502 and optically coupled to the optical network of glass substrate 502. Accordingly, optical coupling components 605 may include any suitable optical coupling mechanism for optically coupling optical fiber 505 (or fiber array) to glass substrate 502 including, but not limited to, grating couplers, edge couplers, fiber attach units, or other coupling mechanism.

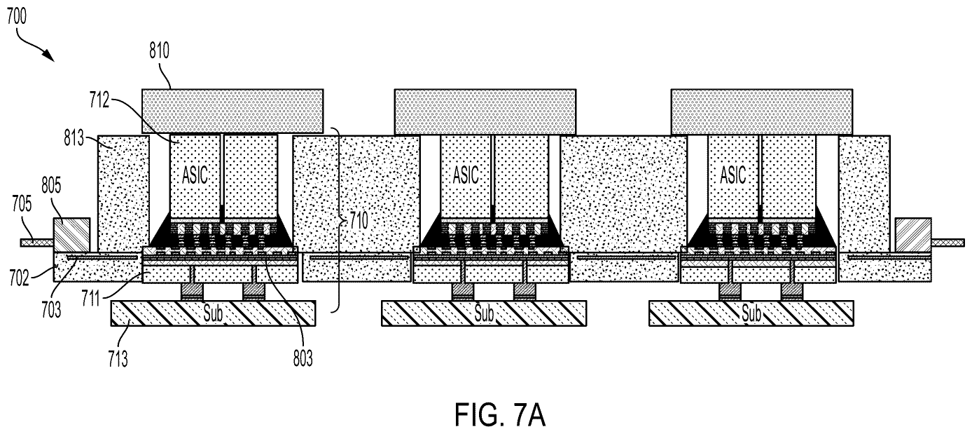

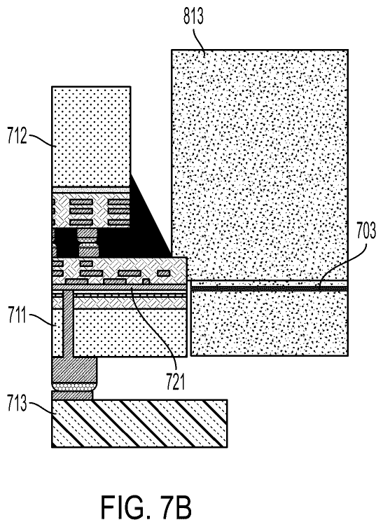

In some embodiments, the PIC waveguides may be optically coupled to glass waveguides in the glass substrate through edge coupling. Edge coupling may be done by aligning the PIC waveguides to be substantially in the same plane as the glass waveguides. Edge coupling may enable pluggable coupling of the assemblies to the glass substrate without using additional optical couplers. FIG. 7A illustrates a cross sectional view of a photonic device 700 having a plurality of optoelectronic assemblies 710 optically coupled with a glass substrate 702 through edge coupling, according to some embodiments. Photonic device 700 is similar to the photonic devices 100 and 500 described above in including glass substrate 702 having an optical network and a plurality of optoelectronic assemblies 710 disposed therein. However, rather than being optically coupled through optical couplers or evanescent coupling, the assemblies are optically coupled to the optical network of glass substrate 702 via edge coupling.

Optoelectronic assemblies 710 may be inserted into the openings of glass substrate 702 until PIC waveguides 803 are aligned with glass waveguides 703. To ensure proper alignment, the opening of cladding 813 may be slightly smaller in diameter than the opening of glass substrate 702. In that way, the waveguides may be aligned when the assemblies are inserted into the opening of glass substrate 702 when PIC 711 abuts cladding 813. Fine-tuned alignment may be achieved in some embodiments by Z referencing on the glass substrate 702 or in PIC 711.

In some embodiments, glass waveguides 703 of glass substrate 702 may comprise tapered waveguides. Tapered waveguides may enable a wider mode field diameter (e.g., approximately 9 μm) which may be more tolerant to alignment inaccuracies than other waveguides.

The optoelectronic assemblies 710 and glass substrate 702 may be manufactured and assembled in similar manners as described above with respect to FIGS. 3 and 4. Namely, each may be assembled separately and the assemblies may be plugged into respective openings of glass substrate 702. However, PICs 711 may be etched with an additional ledge to engage with cladding 813 of glass substrate 702. FIG. 7B illustrates a zoomed in view of the photonic device of FIG. 7A, according to some embodiments. The region illustrated in FIG. 7B shows the interaction between PIC 711 and cladding 813 when PIC 711 is inserted into an opening of glass substrate 702. Rather than being inserted until optical couplers of the PIC and glass substrate are coupled as described above with respect to FIGS. 3 and 4, optoelectronic assemblies 710 are inserted through the openings of glass substrate 702 until ledge 721 abuts cladding 813. The interaction between ledge 721 and cladding 813 may ensure alignment of PIC waveguides 803 and glass waveguides 703. While rectangular cladding is shown, cladding 813 may be of any suitable shape. For example, in some embodiments, cladding 813 conforms to a profile of optoelectronic assemblies 710 to minimize gaps between the assemblies and glass substrate 702.

Optoelectronic assemblies 710 may be secured within the openings of glass substrate 702 in any suitable manner. In some embodiments, optoelectronic assemblies 710 may be secured to substrate 702 using index-matched epoxy. Additionally or alternatively, in some embodiments, optoelectronic assemblies 710 may be secured to substrate 702 using brackets (e.g., as described with respect to brackets 220) to engage substrate 713 of the assemblies.

Having thus described several aspects and embodiments of the technology of this application, it is to be appreciated that various alterations, modifications, and improvements will readily occur to those of ordinary skill in the art. Such alterations, modifications, and improvements are intended to be within the spirit and scope of the technology described in the application. It is, therefore, to be understood that the foregoing embodiments are presented by way of example only and that, within the scope of the appended claims and equivalents thereto, inventive embodiments may be practiced otherwise than as specifically described. In addition, any combination of two or more features, systems, articles, materials, and/or methods described herein, if such features, systems, articles, materials, and/or methods are not mutually inconsistent, is included within the scope of the present disclosure.

Also, as described, some aspects may be embodied as one or more methods. The acts performed as part of the method may be ordered in any suitable way. Accordingly, embodiments may be constructed in which acts are performed in an order different than described, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified.

The terms “approximately” and “about” may be used to mean within ±20% of a target value in some embodiments, within ±10% of a target value in some embodiments, within ±5% of a target value in some embodiments, and yet within ±2% of a target value in some embodiments. The terms “approximately” and “about” may include the target value.

What is claimed is:

1. A photonic device, comprising:
a glass substrate, having a first surface and a second surface opposite the first surface, comprising:
an optical network having one or more glass waveguides; and
a plurality of openings extending through the glass substrate from the first surface to the second surface; and
a plurality of assemblies secured within respective ones of the plurality of openings, each assembly comprising:
a photonic integrated circuit (PIC) having a waveguide optically coupled to at least one glass waveguide of the one or more glass waveguides; and
an application-specific integrated circuit (ASIC) attached to the PIC.

2. The photonic device of claim 1, wherein the one or more glass waveguides are formed adjacent the first surface of the glass substrate, the photonic device further comprising a glass cladding disposed on the first surface of the glass substrate.

3. The photonic device of claim 1, wherein the waveguide of the PIC is optically coupled to the at least one glass waveguide by a first optical coupler disposed on the glass substrate and a second optical coupler disposed on the PIC.

4. The photonic device of claim 3, wherein the second optical coupler is disposed in a recess formed in the PIC.

5. The photonic device of claim 3, wherein the first optical coupler comprises a first mirror and the second optical coupler comprises a second mirror.

6. The photonic device of claim 1, wherein the waveguide of the PIC is optically coupled to the at least one glass waveguide by evanescent coupling.

7. The photonic device of claim 1, wherein the waveguide of the PIC is optically coupled to the at least one glass waveguide by edge coupling.

8. The photonic device of claim 7, wherein the PIC defines a ledge configured to engage with a cladding disposed on the glass substrate to enable edge coupling between the waveguide of the PIC and the at least one glass waveguide.

9. The photonic device of claim 1, wherein each of the PICS of the plurality of assemblies is attached to a distinct substrate.

10. The photonic device of claim 1, wherein the PICS of the plurality of assemblies are attached to a same substrate.

11. The photonic device of claim 1, further comprising a bracket attached to the glass substrate and configured to secure the assemblies within the openings of the glass substrate.

12. The photonic device of claim 1, further comprising one or more heat sinks thermally coupled to the ASICs at the second surface of the glass substrate.

13. A method of assembling a photonic device, the method comprising:
obtaining a plurality of photonic integrated circuits (PICs), each PIC having a waveguide patterned thereon;
attaching a plurality of application-specific integrated circuit (ASICs) to respective PICs of the plurality of PICs to form a plurality of assemblies; and
inserting the plurality of assemblies into respective openings of a glass substrate, wherein the openings extend from a first surface of the glass substrate to a second surface of the glass substrate opposite the first surface, wherein inserting the plurality of assemblies into the respective openings comprises optically coupling glass waveguides of the glass substrate to respective waveguides of the PIC.

14. The method of claim 13, wherein inserting the plurality of assemblies into the respective openings of the glass substrate comprises exposing the ASICs at the second surface of the glass substrate.

15. The method of claim 14, further comprising attaching one or more heat sinks to the second surface of the glass substrate such that the one or more heat sinks is in thermal contact with the ASICs.

16. The method of claim 13, further comprising:
etching the plurality of PICs to form a recess in each PIC; and
placing a first plurality of optical couplers in respective recesses of the PICS, wherein when the plurality of assemblies are inserted into the respective openings, the glass waveguides of the glass substrate are optically coupled to the respective waveguides of the PIC through the first optical couplers.

17. The method of claim 16, further comprising:
etching the glass substrate to form a plurality of recesses; and
placing a second plurality of optical couplers in the recesses of the glass substrate, wherein when the plurality of assemblies are inserted into the respective openings, the glass waveguides of the glass substrate are optically coupled to the respective waveguides of the PIC through the first and second plurality of optical couplers.

18. The method of claim 13, further comprising securing the plurality of assemblies to the glass substrate using one or more brackets.

19. The method of claim 13, further comprising attaching the plurality of assemblies to a common substrate.

20. The method of claim 13, further comprising attaching the plurality of assemblies to respective substrates of a plurality of substrates.
